(19) United States
(12) Patent Application Publication
(10) Pub. No.: US 2025/0170706 A1
(43) Pub. Date: May 29, 2025

(54) ROBOT HAND SYSTEM, CONTROL METHOD, ROBOT HAND, AND CONTROL DEVICE

(71) Applicant: KYOCERA Corporation, Kyoto-shi, Kyoto (JP)

(72) Inventors: Yuki YAMAGISHI, Osaka-shi, Osaka (JP); Hiroaki MIYAMURA, Fujisawa-shi, Kanagawa (JP); Takayuki ISHIDA, Hirakata-shi, Osaka (JP); Naohiro ANAN, Nishinomiya-shi, Hyogo (JP)

(21) Appl. No.: 18/841,911

(22) PCT Filed: Mar. 1, 2023
(86) PCT No.: PCT/JP2023/007686

§ 371 Date: Aug. 27, 2024

(30) Foreign Application Priority Data
Mar. 1, 2022 (JP) 2022-031301

(51) Int. Cl. B25J 9/16; B25J 13/08; B25J 15/02

(52) U.S. Cl. CPC B25J 9/1612; B25J 13/088; B25J 15/026

(57) ABSTRACT

A robot hand system includes a robot hand and a control device. The robot hand includes at least one holding unit, a driving unit, an encoder, and a sensor. The holding unit is configured to hold a holding target 8. The driving unit is configured to move the holding unit. The encoder is configured to detect a movement distance of the holding unit. The sensor is configured to detect a magnet disposed around the holding unit and a positional change with respect to the magnet. The control device is configured to control the driving unit based on outputs of the sensor and the encoder. Either the magnet or the sensor is disposed so as to be able to move in accordance with movement of the holding unit.

### CROSS-REFERENCE TO RELATED APPLICATIONS

This application claims priority of Japanese Patent Application No. 2022-31301 (filed Mar. 1, 2022), the entire disclosure of which is hereby incorporated by reference.

### TECHNICAL FIELD

The present disclosure relates to a robot hand system, a control method, a robot hand, and a control device.

### BACKGROUND OF INVENTION

A known device is configured to calibrate the origin of a movable body by making the movable body collide with a stopper (see, for example, Patent Literature 1).

### CITATION LIST

### Patent Literature

Patent Literature 1: Japanese Unexamined Patent Application Publication No. 9-138706

### SUMMARY

In an embodiment of the present disclosure, a robot hand system includes a robot hand and a control device 80. The robot hand includes at least one holding unit, a driving unit, an encoder, and a sensor. The at least one holding unit is configured to hold a holding target. The driving unit is configured to move the holding unit. The encoder is configured to detect a movement distance of the holding unit. The sensor is configured to detect a magnet disposed around the holding unit and a positional change with respect to the magnet. The control device is configured to control the driving unit based on outputs of the sensor and the encoder. Either the magnet or the sensor is disposed so as to be capable of moving in accordance with movement of the holding unit.

In an embodiment of the present disclosure, a control method includes controlling the robot hand system.

In an embodiment of the present disclosure, a robot hand includes at least one holding unit, a driving unit, an encoder, and a sensor. The at least one holding unit is configured to hold a holding target. The driving unit is configured to move the holding unit. The encoder is configured to detect a movement distance of the holding unit. The sensor is configured to detect a magnet and a positional relationship with the magnet. Either the magnet or the sensor is disposed so as to be capable of moving in accordance with movement of the holding unit.

In an embodiment of the present disclosure, a control device is configured to control the robot hand.

### BRIEF DESCRIPTION OF THE DRAWINGS

FIG. 1 is a schematic diagram illustrating an example configuration of a robot hand system according to an embodiment.

FIG. 2 is a perspective view illustrating an example configuration of a robot hand according to an embodiment.

FIG. 3 is a block diagram illustrating an example configuration of a robot hand system according to an embodiment.

FIG. 4 is a side view illustrating an example of an initial state of the robot hand.

FIG. 5 is a side view illustrating a state in which the robot hand is moved to a movement limit point.

FIG. 6 is a side view illustrating a state in which the robot hand is moved to a detection position.

FIG. 7 is a side view illustrating a state in which the robot hand is moved to a target position.

FIG. 8 is a diagram illustrating an example of the relationship between the positions of a sensor and a magnet, and sensor output when the robot hand is moved to the detection position.

FIG. 9 is a flowchart illustrating an example procedure of a control method of a robot hand system according to an embodiment.

FIG. 10 is a diagram illustrating an example of the relationship between the positions of a sensor and a magnet, and sensor output when the robot hand is moved to the movement limit point.

FIG. 11 is a diagram illustrating an example of the relationship between the positions of a sensor and a magnet, and sensor output when the robot hand is moved to a detection position when the sensor output is asymmetrical.

FIG. 12 is a diagram illustrating an example of the relationship between the positions of a sensor and a magnet, and sensor output when the robot hand is moved to a detection position when the sensor output steeply changes.

FIG. 13 is a diagram illustrating an example of the relationship between the positions of two sensors and a magnet, two sensor outputs, and the difference between the two sensor outputs when the robot hand is moved to the detection position.

### DESCRIPTION OF EMBODIMENTS

When detecting the absolute position of a robot hand, if the robot hand is moved until the robot hand collides with a stopper or is moved to the limit of movement of the robot hand, the frequency of maintenance of the robot hand may increase due to the load on the drive mechanism of the robot hand. Maintenance of the robot hand may result in reduced work efficiency. In addition, work efficiency may be reduced due to the robot hand being moved away from the area where work is actually performed. Improved work efficiency is required for robot hands.

### (Example Configuration of Robot Hand System 1)

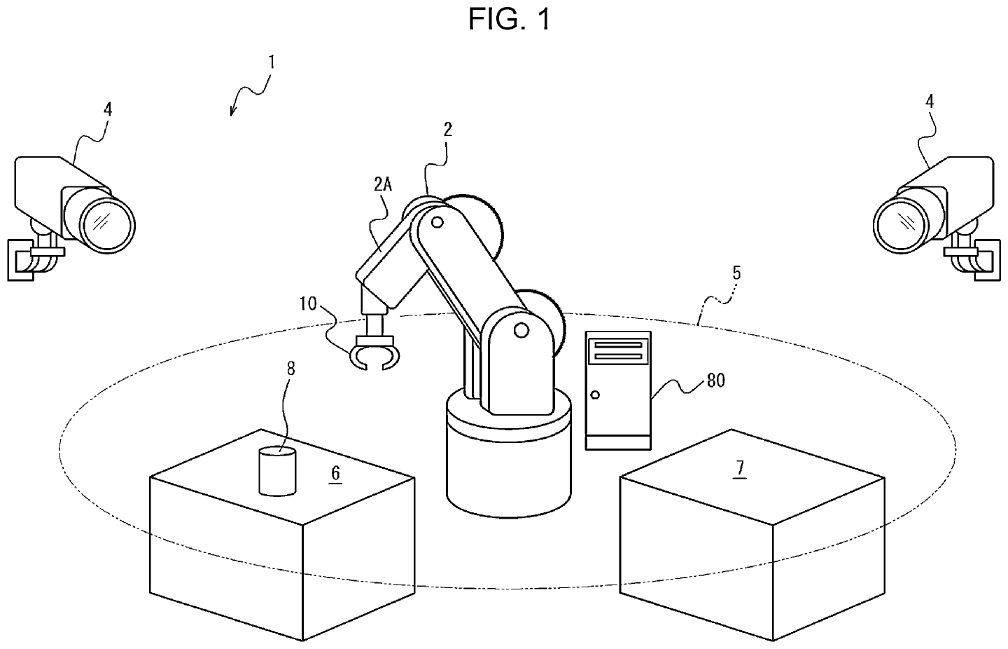

As illustrated in FIG. 1, in an embodiment of the present disclosure, a robot hand system 1 includes a robot hand 10 and a control device 80. The robot hand 10 is attached to an arm 2A of a robot 2. The control device 80 controls the arm 2A and the robot hand 10. The robot hand system 1 may further include an information acquiring unit 4. The control device 80 may control the robot 2 so that the robot 2 picks up a holding target 8 at a work start bench 6 and moves the holding target 8 from the work start bench 6 to a work destination bench 7. The robot 2 operates inside an operation range 5.

### <Robot 2>

The arm 2A of the robot 2 may be configured, for example, as a six-axis or seven-axis vertically articulated robot. The arm 2A may be configured as a three-axis or four-axis horizontally articulated robot or a SCARA robot. The arm 2A may be configured as a two-axis or three-axis Cartesian robot. The arm 2A may be configured as a parallel link robot or the like. The number of axes of the arm 2A is not limited to those in the given examples. In other words, the robot 2 includes the arm 2A connected by multiple joints and is operated by driving the joints.

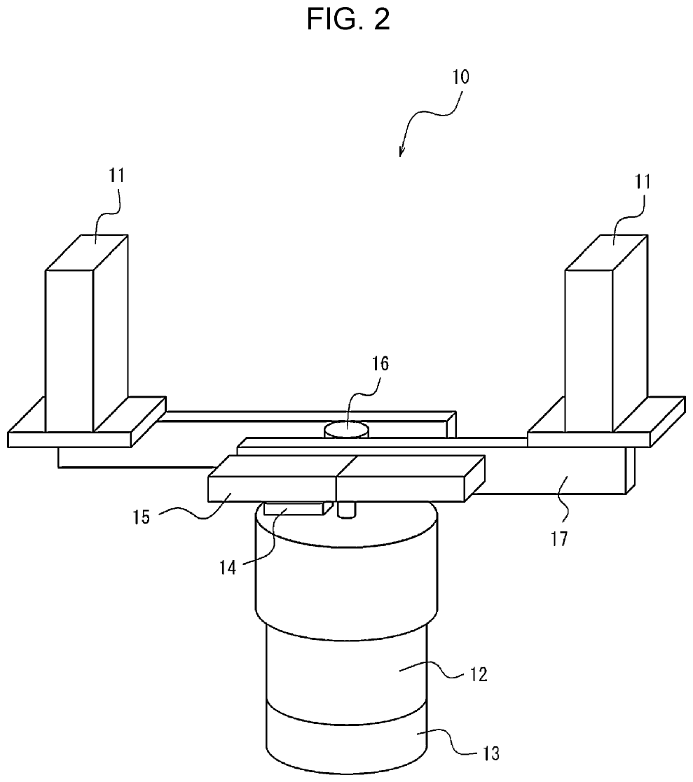

As illustrated in FIG. 2, in an embodiment of the present disclosure, the robot hand 10 includes a holding unit 11, a driving unit 12, and an encoder 13. The holding unit 11 is configured to hold the holding target 8. The driving unit 12 is configured to move the holding unit 11. The encoder 13 is configured to detect the position of the driving unit 12. Let us assume that the holding unit 11 is configured as two fingers, and is configured to be capable of holding the holding target 8 by pinching the holding target 8 between the two fingers. The holding unit 11 may include three or more fingers. The holding unit 11 may be configured as a single finger, and so as to be capable of holding the holding target 8 by applying suction to the holding target 8 via a suction unit provided in the finger.

Let us assume that the driving unit 12 includes a motor. The driving unit 12 may be configured in various ways in order to move the holding unit 11, not limited to a motor. Let us assume that the encoder 13 includes an incremental encoder or the like that detects the relative position of the motor. The encoder 13 may be configured in various ways. The encoder 13 outputs an amount of rotation of the driving unit 12 as a count.

Let us assume that the holding unit 11 is mounted on a rail 17, which is moved linearly by rotation of a gear 16. The rail 17 includes a rack that meshes with the gear 16. The driving unit 12 rotates the gear 16. The rotation of the gear 16 causes the rail 17 to undergo linear motion. In other words, the rotational motion of the driving unit 12 is converted into the linear motion of the rail 17 by the combination of the gear 16 and the rack of the rail 17. The holding unit 11 is linearly displaced by the rail 17 undergoing linear motion. When the holding unit 11 is configured as two fingers, one finger is attached to one rail 17. In this case, the robot hand 10 includes two rails 17. The two rails 17 are configured to mesh with one gear 16. The rotation of gear 16 causes the two rails 17 to move in opposite directions from each other. As a result, fingers of the holding unit 11 move in opposite directions from each other. The fingers of the holding unit 11 pinch and hold the holding target 8 therebetween by moving in directions toward each other. The holding unit 11 releases the pinched holding target 8 by moving the fingers in directions away from each other. The encoder 13 outputs an amount of rotation of the driving unit 12 as a count. The amount of rotation of the driving unit 12 is converted into the amount of displacement of the linear motion of the rail 17 and the holding unit 11 attached to the rail 17. Therefore, the count output by the encoder 13 represents the amount of displacement of the holding unit 11 or the distance moved by the holding unit 11.

The driving unit 12 may be configured as a linear motor. In this case, the rail 17 is included in the driving unit 12. In addition, the gear 16 is not needed.

The robot hand 10 further includes a sensor 14 and a magnet 15. The sensor 14 and the magnet 15 are used to detect the position of the holding unit 11, as described below. Let us assume that the sensor 14 is attached to the rail 17. In this case, the sensor 14 moves together with the holding unit 11. Let us assume that the magnet 15 is attached to a configuration including the driving unit 12 and the encoder 13. In this case, the magnet 15 is fixed in place in the robot hand 10. Conversely, the magnet 15 may be attached to the rail 17 and move together with the holding unit 11, and the sensor 14 may be attached and fixed to a configuration that includes the driving unit 12 and the encoder 13. In other words, either the sensor 14 or the magnet 15 is disposed so as to be able to move in accordance with movement of the holding unit 11. The magnet 15 can also be said to be disposed around the holding unit 11. The sensor 14 is configured to be able to detect the magnet 15 disposed around the holding unit 11 and positional changes with respect to the magnet 15. The sensor 14 may be a Hall sensor or a resolver, for example. The magnet 15 may be a permanent magnet or an electromagnet.

### <Control Device 80>

The control device 80 can control the position of the robot hand 10 by operating the arm 2A of the robot 2. The robot hand 10 may have axes serving as references for directions of action with respect to the holding target 8. When the robot hand 10 has axes, the control device 80 can control the direction of the axes of the robot hand 10 by operating the arm 2A. The control device 80 controls the start and end of the operation of the robot hand 10 acting on the holding target 8. The control device 80 can move or manipulate the holding target 8 by controlling the position of the robot hand 10 or the directions of the axes of the robot hand 10, while controlling the operation of the robot hand 10. In the configuration illustrated in FIG. 1, the control device 80 controls the robot 2 to cause the robot hand 10 to pick up the holding target 8 at the work start bench 6 and move the robot hand 10 to the work destination bench 7. The control device 80 controls the robot 2 to cause the robot hand 10 to release the holding target 8 at the work destination bench 7. In this way, the control device 80 can move the holding target 8 from the work start bench 6 to the work destination bench 7 using the robot 2.

The control device 80 may include at least one processor. The processor may execute programs that realize various functions of the control device 80. The processor may be implemented as a single integrated circuit. An integrated circuit is also referred to as an IC. The processor may be implemented as multiple integrated circuits and discrete circuits connected so as to be able to communicate with each other. The processor may be realized based on various other known technologies.

The control device 80 may include a recording unit. The recording unit records various data necessary to control the robot hand 10. The recording unit may include an electromagnetic storage medium such as a magnetic disk, or may include a memory such as a semiconductor memory or a magnetic memory. The recording unit may include a non-volatile memory. The recording unit stores various types of information. The recording unit stores programs and so forth executed by the control device 80. The recording unit may be configured as a non-transient readable medium. The recording unit may function as a work memory of the control device 80. At least part of the recording unit may be configured separately from the control device 80.

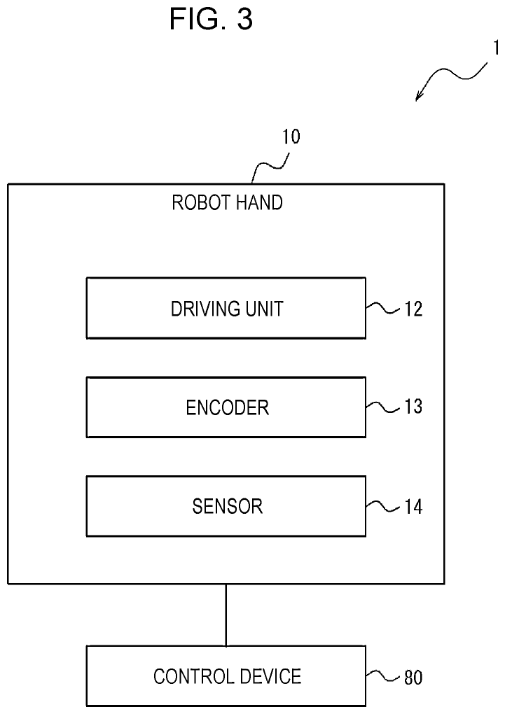

As illustrated in FIG. 3, the control device 80 controls the robot hand 10 in the robot hand system 1. The control device 80 drives the driving unit 12 based on detection results of the encoder 13 so as to move the holding unit 11 and control the position of the holding unit 11.

### <Information Acquiring Unit 4>

The information acquiring unit 4 acquires information on the holding target 8. The information acquiring unit 4 may include a camera. The camera of the information acquiring unit 4 captures images of the holding target 8 as information on the holding target 8. The information acquiring unit 4 may include a depth sensor. The depth sensor of the information acquiring unit 4 acquires depth data of the holding target 8. The depth data may be converted to point cloud information for the holding target 8. Information acquired by the information acquiring unit 4 can be output to the control device 80.

### (Example Operation of Robot Hand System 1)

In the robot hand system 1, the control device 80 controls the arm 2A and the robot hand 10 to cause the robot 2 to perform work. The control device 80 controls the arm 2A to bring the robot hand 10 closer to the holding target 8, and controls the robot hand 10 to open and close the holding unit 11, for example, to hold the holding target 8 in the holding unit 11 of the robot hand 10.

The control device 80 controls the position of the holding unit 11 by driving the driving unit 12 based on detection results of the encoder 13. When the encoder 13 detects the relative position of the driving unit 12, the control device 80 controls the relative position of holding unit 11. The encoder 13 can detect the relative position from the position of the holding unit 11 at activation of the robot hand 10. In other words, the control device 80 controls the position of the holding unit 11 as a relative position from the position upon activation of the robot hand 10. Activation of the robot hand 10 can also be referred to as turning on the power of the robot hand 10.

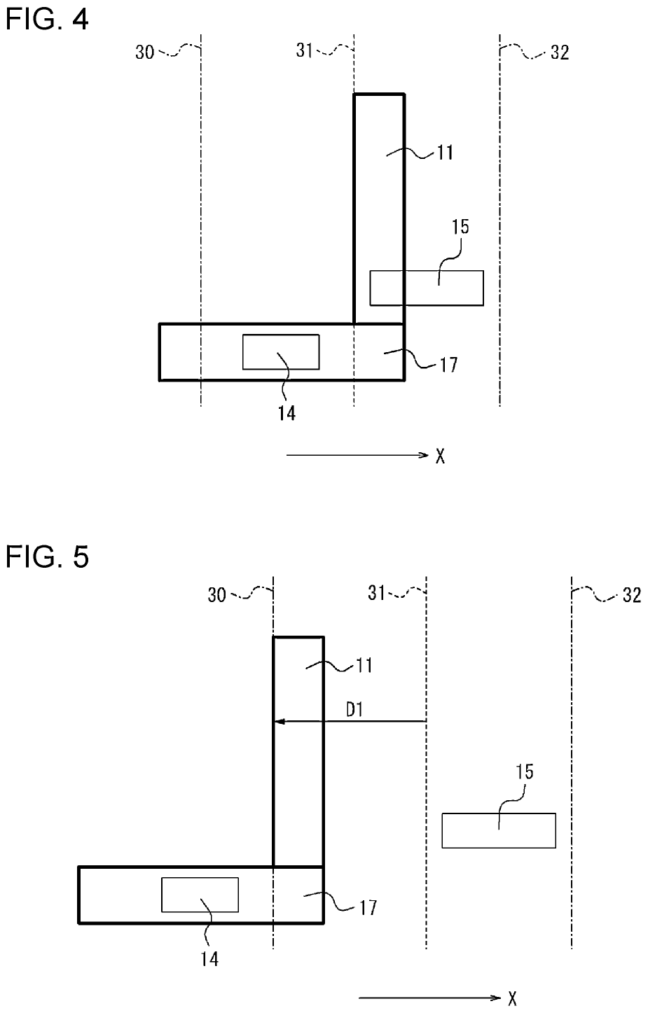

For example, the position of the holding unit 11 upon activation of the robot hand 10 is not fixed. The control device 80 acquires the position of the holding unit 11 at activation of the robot hand 10. The control device 80 performs an initial operation in order to acquire the position of the holding unit 11 upon activation of the robot hand 10. Specifically, as illustrated in FIG. 4, the holding unit 11 is located at an initial position 31 upon activation of the robot hand 10. In this embodiment, the two fingers move symmetrically, and therefore only one finger of the holding unit 11 is illustrated in FIG. 4. The control device 80 moves the holding unit 11 to a movement limit point 30 as illustrated in FIG. 5 as an initial operation. In this embodiment, since the two fingers move symmetrically, only one finger of the holding unit 11 is illustrated in FIG. 5. When the holding unit 11 is configured as two or more fingers, the movement limit point 30 may be a position at which members such as the rails 17 driving the two or more fingers contact each other and cannot move any further. The movement limit point 30 may be a state in which the two or more fingers are located in closest proximity to each other. The movement limit point 30 may correspond to a position where the two or more fingers are closed. The movement limit point 30 is also referred to as a hand reference position.

The control device 80 acquires the amount of displacement for when the holding unit 11 is moved from the initial position 31 to the movement limit point 30 using the encoder 13. The amount of displacement when moving from the initial position 31 to the movement limit point 30 is represented as D1 and is also referred to as an initial displacement. The amount of displacement may also be referred to as a count of the encoder 13. In FIGS. 4 and 5, the holding unit 11 moves along an X axis. The initial position 31 is located farther in the positive direction of the X axis than the movement limit point 30. Therefore, D1, which represents the amount of displacement in the negative direction of the X axis from the initial position 31 to the movement limit point 30, is negative.

If the holding unit 11 is moved to the movement limit point 30 each time the robot hand 10 is activated, the holding unit 11 or members driving the holding unit 11 will be prone to wear and deterioration. In addition, the robot hand 10 cannot be used immediately after activation and convenience is reduced due to the time required for the initial operation. By using the sensor 14 and the magnet 15, the control device 80 according to this embodiment can acquire the position of the holding unit 11 without moving the holding unit 11 to the movement limit point 30. The magnet 15 is fixed in place. The sensor 14 moves along the X axis together with the holding unit 11. Based on the detection results of the sensor 14, the control device 80 can acquire the positional relationship between the sensor 14 and the magnet 15 in the X-axis direction.

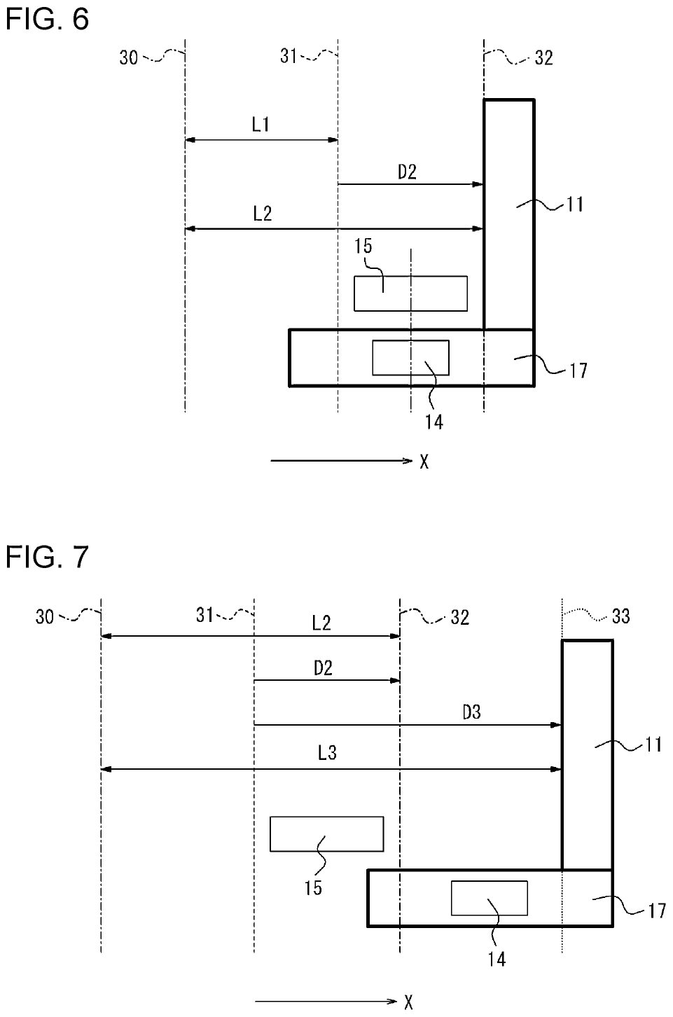

The control device 80 sets in advance the positional relationship in the X-axis direction between the sensor 14 and the magnet 15 when the holding unit 11 is positioned at a detection position 32. Conversely, the control device 80 may set the detection position 32 as the position of the holding unit 11 when the positional relationship in the X-axis direction between the sensor 14 and the magnet 15 is a prescribed relationship. The control device 80 may set the detection position 32 as the position of the holding unit 11 when the position of the sensor 14 in the X-axis direction and the position of the magnet 15 in the X-axis direction coincide with each other at a position indicated by a single-dot chain line as illustrated in FIG. 6. In other words, the control device 80 may set the prescribed relationship as a relationship in which the position of the sensor 14 in the X-axis direction and the position of the magnet 15 in the X-axis direction coincide with each other.

The control device 80 may determine that the holding unit 11 has moved to the detection position 32 when the positional relationship between the sensor 14 and the magnet 15 is the prescribed relationship. The control device 80 acquires the amount of displacement when the holding unit 11 is moved from the initial position 31 to the detection position 32 as the count of the encoder 13. The amount of displacement when moving from the initial position 31 to the detection position 32 is represented as D2 and is also referred to as a first relative displacement. In FIG. 6, the holding unit 11 moves along the X axis. If the initial position 31 is located further in the negative direction of the X axis than the detection position 32, the holding unit 11 is displaced in the positive direction of the X axis from the initial position 31 to the detection position 32. D2 representing this displacement has a positive value. If the initial position 31 is located further in the positive direction of the X axis than the detection position 32, the holding unit 11 is displaced in the negative direction of the X axis from the initial position 31 to the detection position 32. D2 representing this displacement has a negative value.

The control device 80 can obtain a distance (L1) from the movement limit point 30 to the initial position 31 based on the initial operation. The control device 80 can calculate L1 as −D1. The control device 80 can calculate a distance (L2) from the movement limit point 30 to the detection position 32 as L1+D2. The amount of displacement of the holding unit 11 from the movement limit point 30 to the detection position 32 is a positive value and corresponds to the distance (L2) from the movement limit point 30 to the detection position 32. The amount of displacement of the holding unit 11 from the movement limit point 30 to the detection position 32 is also referred to as a first absolute displacement. The first absolute displacement is calculated by adding the first relative displacement (D2) to the distance (L1) from the movement limit point 30 to the initial position 31. In other words, the first absolute displacement is calculated as L1+D2 or −D1+D2. The control device 80 records the first absolute displacement in the recording unit. The control device 80 may record the first absolute displacement in a non-volatile memory as the recording unit. The control device 80 may convert the distance or amount of displacement into a count of the encoder 13 to perform calculations.

Each time the robot hand 10 is activated, the initial position 31 can be a different position. The control device 80 acquires the first relative displacement when the robot hand 10 is activated. Different initial positions 31 result in the first relative displacement having a different value each time the robot hand 10 is activated. The control device 80 can convert the amount of displacement of the holding unit 11 detected by the encoder 13 to the actual position of the holding unit 11 based on the first absolute displacement acquired in advance by the initial operation and the first relative displacement acquired when the robot hand 10 is activated. In other words, the control device 80 can calculate the amount of displacement of the holding unit 11 from the movement limit point 30 based on the detection results of the encoder 13 when the holding unit 11 moves to the detection position 32, without needing to perform the initial operation each time the robot hand 10 is activated.

The control device 80 moves the holding unit 11 to a target position 33 as illustrated in FIG. 7 in order to hold the holding target 8 with the holding unit 11. The amount of displacement from the initial position 31 to the target position 33 is represented as D3 and is also referred to as a second relative displacement. The control device 80 identifies the target position 33 using the amount of displacement from the movement limit point 30. The amount of displacement from the movement limit point 30 to the target position 33 is also referred to as a second absolute displacement. The second absolute displacement is positive and corresponds to the distance from the movement limit point 30 to the target position 33. The distance from the movement limit point 30 to the target position 33 is represented by L3.

The control device 80 acquires the first absolute displacement in advance, as described above. In other words, the control device 80 controls the position of the holding unit 11 based on the first absolute displacement and the detection results of the encoder 13 and moves the holding unit 11 to the target position 33. The control device 80 calculates the difference between the second absolute displacement and the first absolute displacement in order to move the position of the holding unit 11 to the target position 33 identified by the second absolute displacement. The difference between the second absolute displacement and the first absolute displacement is also referred to as a correction displacement. The control device 80 can acquire the first relative displacement (D2) and the second relative displacement (D3) in an operation performed after activating the robot hand 10. Therefore, the control device 80 can calculate the correction displacement as D3−D2. The second relative displacement may be smaller than the first relative displacement.

The control device 80 acquires the distance (L2) corresponding to the first absolute displacement in advance. The control device 80 can calculate the correction displacement as D3−D2. Based on the distance (L2) corresponding to the first absolute displacement and the correction displacement (D3−D2), the control device 80 can calculate a distance (L3) corresponding to the second absolute displacement as L2+D3−D2. L2 is a constant that is determined based on the configuration of the robot hand 10. D2 is a constant determined based on the initial position 31 upon activation the robot hand 10. The control device 80 moves the holding unit 11 to the target position 33 by controlling D3.

The displacement from the movement limit point 30 to the target position 33 is also referred to as a target displacement. The target displacement can be said to be the displacement with respect to the movement limit point 30 before holding of the holding target 8 is performed. The target position 33 can be determined by the control device 80 based on information about the holding target 8 obtained from the information acquiring unit 4. The target position 33 is, for example, a count value that can be compared to the value of the encoder 13 corresponding to the amount of displacement from the movement limit point 30 to the target position 33. The control device 80 may then determine the suitability of the position of the holding unit 11 by comparing the target displacement with the second absolute displacement. The target position 33 can be changed depending on the holding target 8. Depending on the size of the holding target 8, the target position 33 may be set inside (−X-axis side) of a second movement limit point (the position where the distance between the holding units 11 is the maximum when there are two holding units 11) when the holding unit 11 is positioned furthermost toward the outside (+X-axis side in FIG. 4).

As discussed above, in the robot hand system 1 according to this embodiment, the control device 80 can acquire the absolute position of the holding unit 11 without moving the holding unit 11 to the movement limit point 30 each time the robot hand 10 is activated. In this way, the load on the drive mechanism of the robot hand 10 can be reduced. The frequency of maintenance can be reduced by this reduction in load. This also eliminates the need for an initial operation in which the robot hand 10 is moved away from the area where the work will actually be performed. As a result, the work efficiency of the robot hand 10 can be improved.

In the robot hand system 1 of this embodiment, the control device 80 can acquire the absolute position of the holding unit 11, thereby eliminating the need to move the holding unit 11 to the second movement limit point each time the holding target 8 is to be held, and the load on the drive mechanism of the robot hand 10 can be reduced.

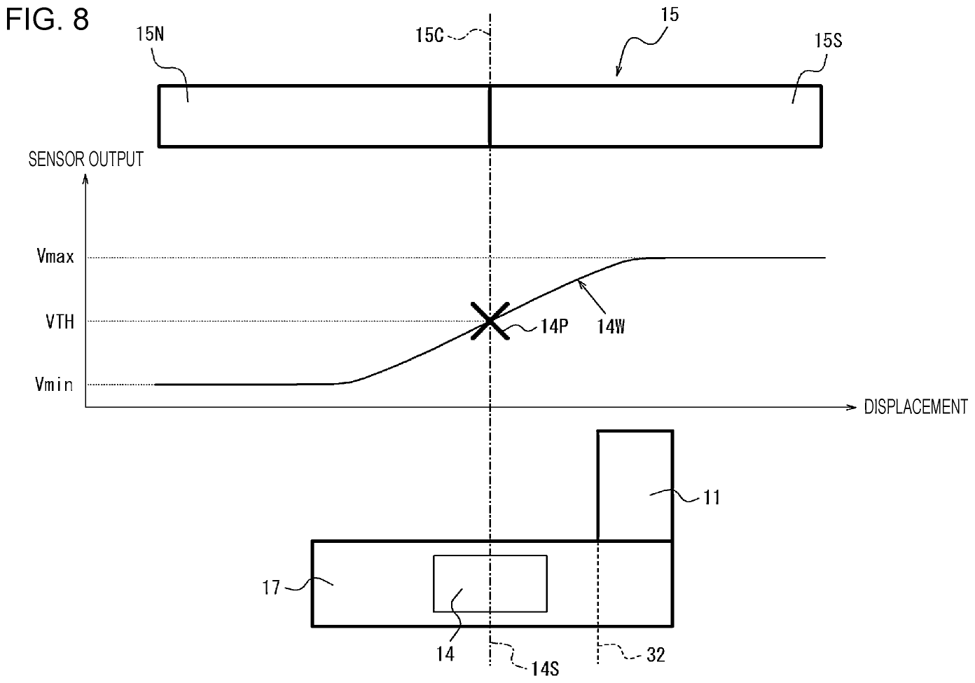

The control device 80 calculates the positional relationship between the sensor 14 and the magnet 15 based on the detection results of the sensor 14. Let us assume that the detection position 32 is set so that a reference position 14S of the sensor 14 and a reference position 15C of the magnet 15 coincide with each other when the holding unit 11 is positioned at the detection position 32, as illustrated in FIG. 8. The reference position 15C of the magnet 15 corresponds to a position midway between an N pole 15N and S pole 15S. The N pole 15N and the S pole 15S are arranged side by side in the movement direction (X-axis direction) of the holding unit 11. The reference position 15C corresponds to a midpoint between the N pole 15N and S pole 15S in the movement direction (X-axis direction) of the holding unit 11. The reference position 14S of the sensor 14 corresponds to the position where the sensor 14 detects the magnetic field of the magnet 15.

The sensor 14 moves together with the holding unit 11 by the same amount of displacement along the X axis. Let us assume that the sensor 14 is configured to output a smaller value the closer the sensor 14 is to the N pole 15N of the magnet 15 and a larger value the closer the sensor 14 is to the S pole 15S of the magnet 15. In this case, in the relationship between displacement and output represented by a waveform 14W of the output of the sensor 14, the output of the sensor 14 is at a minimum (Vmin), or close to a minimum, when the sensor 14 is close to the N pole 15N. The output of the sensor 14 is at a maximum value (Vmax), or close to the maximum value, when the sensor 14 is close to the S pole 15S. At a boundary including the reference position 15C of the magnet 15, the output of the sensor 14 becomes larger the more the sensor 14 is displaced from the N pole 15N toward the S pole 15S. The maximum value of the output of the sensor 14 is determined based on the power supply voltage of the sensor 14. The minimum value of the output of the sensor 14 is determined based on the internal resistance of sensor 14 and so on.

The control device 80 identifies the position of the sensor 14 relative to the magnet 15 based on the output of the sensor 14. The control device 80 can identify the amount of displacement of the sensor 14 with higher accuracy the greater the change in the output of the sensor 14 relative to the amount of displacement of the sensor 14. In the waveform 14W of the output of the sensor 14 illustrated in FIG. 8, the change in the output of the sensor 14 is greater when the position of the sensor 14 is in a range that includes the reference position 15C of the magnet 15. Therefore, the control device 80 may set a threshold (VTH) corresponding to movement of the sensor 14 to a prescribed position in a range where the change in the output of the sensor 14 is greater than or equal to a prescribed value, and set the position of the holding unit 11 when the output of the sensor 14 has reached the threshold as the detection position 32. The intersection of the waveform 14W and the reference position 14S of the sensor 14 when the output of the sensor 14 reaches the threshold is represented by a point 14P. The threshold is also referred to as a prescribed value. The position of the holding unit 11 when the output of the sensor 14 is the prescribed value is also referred to as a sensor reference position.

The control device 80 may set the threshold (VTH) to ½ the maximum value (Vmax) of the output of the sensor 14. The control device 80 may set the threshold (VTH) to the average of the minimum (Vmin) and maximum (Vmax) of the output of the sensor 14. The control device 80 may set the threshold (VTH) to any value from the minimum (Vmin) to the maximum (Vmax) of the output of the sensor 14. The control device 80 may set the threshold (VTH) to a value representing the boundary between the N pole 15N and the S pole 15S of the magnet 15. The control device 80 may set the threshold (VTH) so that the output of the sensor 14 changes in a step-like manner before and after the threshold (VTH).

As mentioned above, in the robot hand system 1 according to this embodiment, the control device 80 can identify the position of the holding unit 11, which is unknown when the robot hand 10 is activated, by using the detection position 32, which is acquired using the sensor 14 and the magnet 15. As a comparative example of a method for identifying the position of the holding unit 11 when the robot hand 10 is activated, a configuration using a mechanical switch can be considered. However, when a mechanical switch is used, errors can occur due to delays or chattering in the response of the mechanical switch. As a comparative example, a configuration in which an optical sensor is used can also be considered. An optical sensor detects light emitted from a light-emitting unit in a light-receiving unit. An error can be caused by foreign matter such as dust entering the space between the light-emitting unit and the light-receiving unit. On the other hand, in the configuration using the sensor 14 and the magnet 15, there is no reaction delay or chattering problem in the mechanical switch. In addition, a level of dustproofing as high as that of an optical sensor is not required. Therefore, the robot hand system 1 according to this embodiment can identify the initial position 31 of the robot hand 10 with high accuracy. Identifying the initial position 31 with high accuracy allows the accuracy of work carried out by the robot hand 10 to be improved. By improving work accuracy, the need to redo work can be avoided. As a result, the work efficiency of the robot hand 10 can be improved.

### <Example of Flowchart>

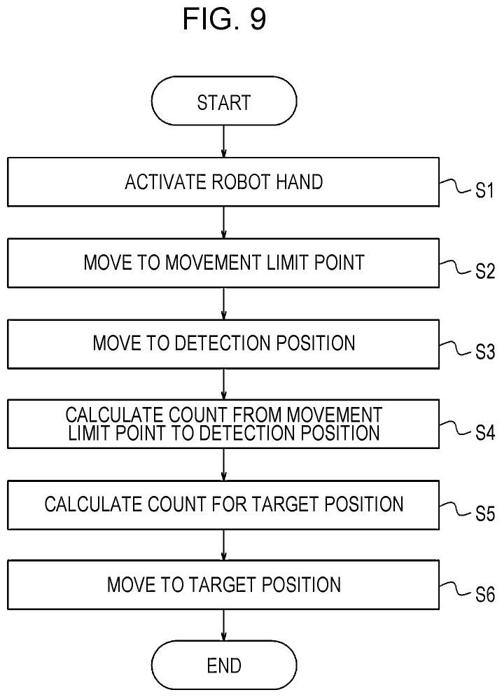

The control device 80 may execute a control method for the robot hand 10 including the procedures of a flowchart illustrated in FIG. 9. The control method may be realized as a robot control program to be executed by a processor constituting the control device 80. The robot control program may be stored on a non-transitory computer-readable medium.

The control device 80 activates the robot hand 10 (Step S1). The control device 80 moves the holding unit 11 from the initial position 31 to the movement limit point 30 (Step S2). The control device 80 acquires the count of the encoder 13 representing the amount of displacement from the initial position 31 to the movement limit point 30.

The control device 80 moves the holding unit 11 to the detection position 32 (Step S3). The control device 80 acquires the count of the encoder 13 representing the amount of displacement from the initial position 31 to the detection position 32. The count of the encoder 13 representing the amount of displacement from the initial position 31 to the detection position 32 corresponds to the first relative displacement.

The control device 80 calculates the count of the encoder 13 representing the amount of displacement from the movement limit point 30 to the detection position 32 based on the count of the encoder 13 acquired in Step S2 and the count of the encoder 13 acquired in Step S3 (Step S4). The count of the encoder 13 representing the amount of displacement from the movement limit point 30 to the detection position 32 corresponds to the first absolute displacement. The control device 80 may store the count corresponding to the first absolute displacement in the recording unit.

The control device 80 calculates the count of the encoder 13 corresponding to the amount of displacement when the holding unit 11 is moved to the target position 33 (Step S5). Specifically, the control device 80 calculates the count from the detection position 32 to the target position 33 based on the count from the movement limit point 30 to the target position 33 and the count representing the first absolute displacement. The count from the detection position 32 to the target position 33 corresponds to the correction displacement.

The control device 80 moves the holding unit 11 to the target position 33 (Step S6). Specifically, the control device 80 controls the driving unit 12 so that the count of the encoder 13 becomes equal to the sum of the count from the initial position 31 to the detection position 32 acquired in Step S3 and the count corresponding to the correction displacement. After executing the procedure of Step S6, the control device 80 may stop the robot hand 10 and terminate execution of the procedures in the flowchart in FIG. 9. After performing the procedure of Step S6, the control device 80 may return to the procedure of Step S5 and move the holding unit 11 to a new target position 33.

### OTHER EMBODIMENTS

The control device 80 identifies the position of the holding unit 11 by moving the holding unit 11 to the detection position 32 when the robot hand 10 is activated. When the holding unit 11 includes two or more fingers, the control device 80 may perform the following operations as confirmation processing.

First, the control device 80 moves each finger of the holding unit 11 until the finger is fully closed. Next, the control device 80 moves each finger of the holding unit 11 until the finger is fully open. At this time, the control device 80 measures the time taken for each finger of the holding unit 11 to move from being fully closed to fully open. The control device 80 judges that operation of the robot hand 10 is normal if the measured time is within a prescribed time, and judges that operation of the robot hand 10 is abnormal if the measured time exceeds the prescribed time, and outputs an error. The prescribed time is set based on the rotational speed of the motor of the driving unit 12 and the distance through which each finger of the holding unit 11 moves from being fully closed to fully open.

Thus, by executing the confirmation processing, abnormalities in the robot hand 10 are more easily detected. By detecting abnormalities in the robot hand 10 early, the need to redo work can be avoided. As a result, the work efficiency of the robot hand 10 can be improved.

The control device 80 can be said to perform the confirmation operation after calculating the first relative displacement. The control device 80 can be said to output an error if the movement of the holding unit 11 is not completed within a prescribed time when the holding unit 11 is moved from one end of a movable range to the other end of the movable range as the confirmation operation.

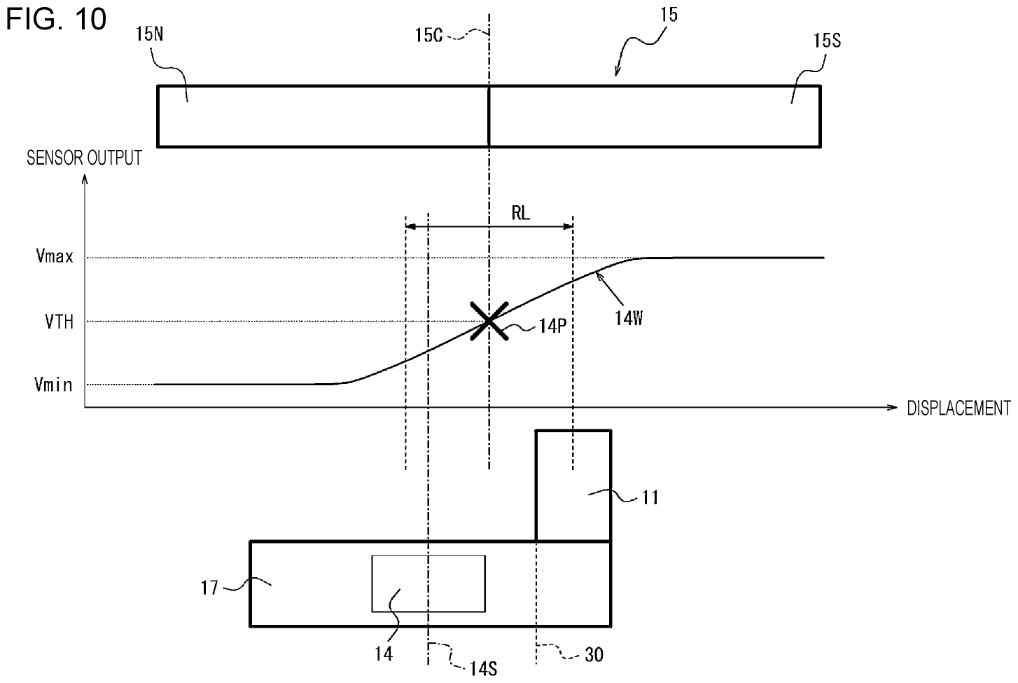

As illustrated in FIG. 10, the robot hand 10 may be configured so that the reference position 14S of the sensor 14 when the holding unit 11 is positioned at the movement limit point 30 is included in a linear range (RL) of the waveform 14W of the output of the sensor 14. This increases the probability that an initial position 31 with a displacement greater than the movement limit point 30 will be included within the linear range of the waveform 14W. The initial position 31 being included within the linear range of the waveform 14W enables the amount of displacement required to move the holding unit 11 to the detection position 32 to be estimated with high accuracy. By estimating the amount of displacement required with high accuracy, the time required to move the holding unit 11 to the detection position 32 can be reduced. As a result, the work efficiency of the robot hand 10 can be improved.

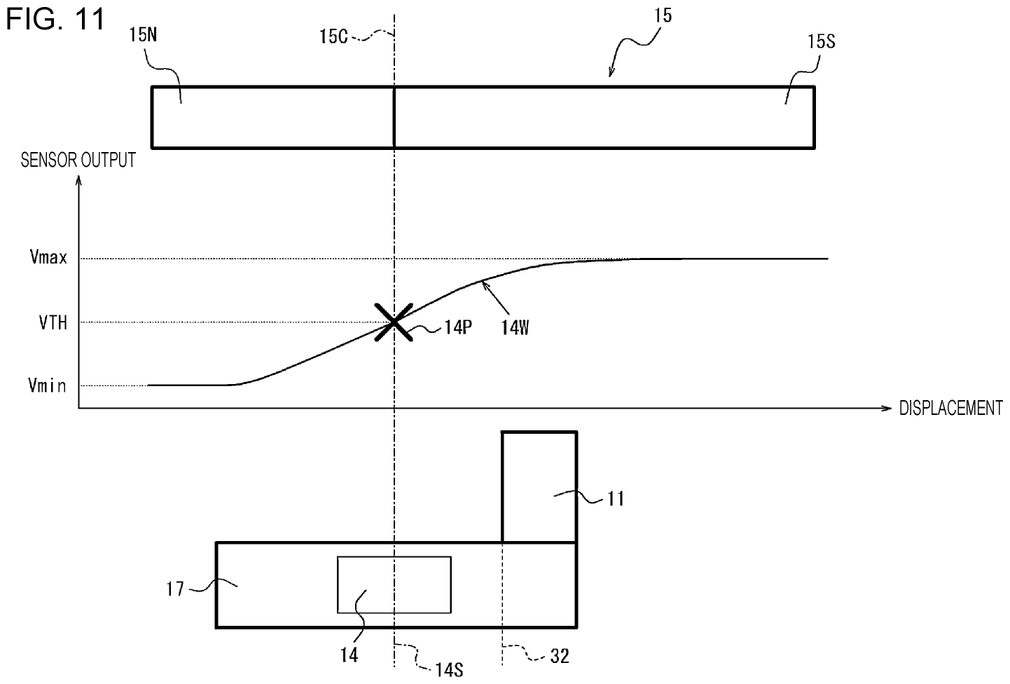

As illustrated in FIG. 11, the magnet 15 may be configured so that the magnetic field produced by the magnet 15 is asymmetrical between the N pole 15N and the S pole 15S. Specifically, the magnetization of magnet 15 may be asymmetrical. Thus, there is no need to vary the positional relationship between the magnet 15 and the sensor 14.

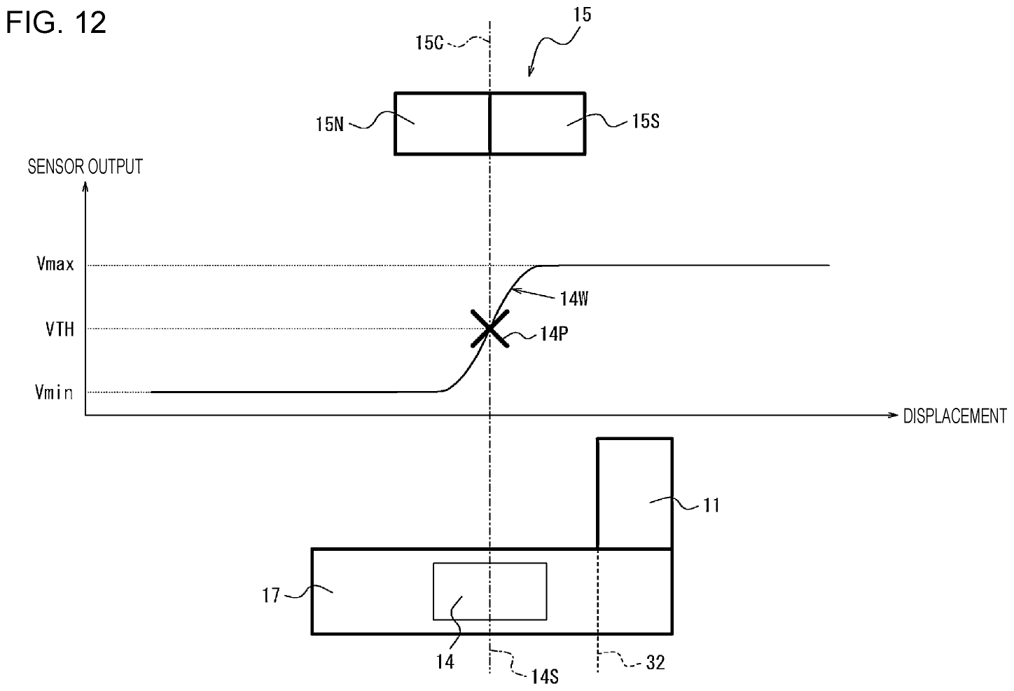

As illustrated in FIG. 12, as the magnet 15, a magnet may be used in which the distance between the N pole 15 and the S pole 15S of the magnet 15 is shortened so that the change in the waveform 14W of the output of the sensor 14 is steeper. In this way, the control device 80 can calculate the amount of displacement from the change in the output of the sensor 14 with high resolution. When the change in the output of the sensor 14 has a value around the through rate of an input terminal of the computer constituting the control device 80, the control device 80 is able to convert the output of the sensor 14 to a digital signal and determine a threshold. Due to the output of the sensor 14 changing steeply, effects from changes in the characteristics of the sensor 14 are less likely to occur. By making the magnet 15 smaller, the robot hand 10 can be made smaller.

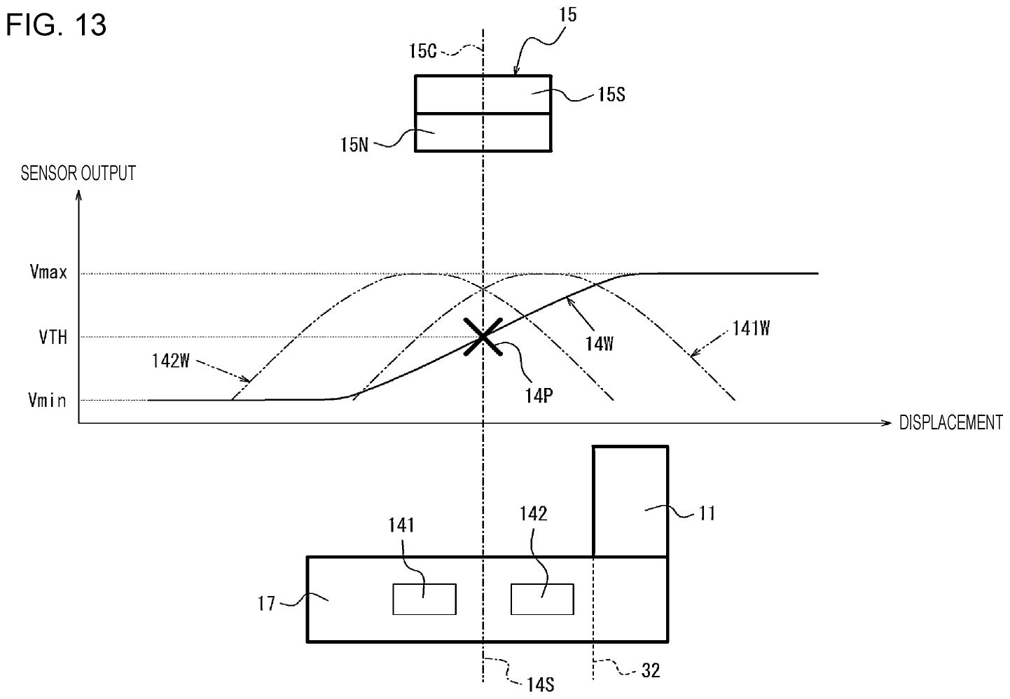

As illustrated in FIG. 13, the magnet 15 may be disposed so that the N pole 15N and S pole 15S of the magnet 15 are arranged side by side in a direction that intersects the movement direction (X-axis direction) of the holding unit 11. In this case, the robot hand 10 includes a first sensor 141 and a second sensor 142 as the sensor 14. Let us assume that the reference position 14S of the sensor 14 is a position midway between the first sensor 141 and the second sensor 142. The output of the first sensor 141 is represented as a waveform 141W. The output of the second sensor 142 is represented as a waveform 142W.

The control device 80 calculates the difference between the output of the first sensor 141 and the output of the second sensor 142 as the output of the sensor 14. The difference between the output of the first sensor 141 and the output of the second sensor 142 is represented as the waveform 14W. In the waveform 14W, the output of the sensor 14 varies linearly with displacement of the holding unit 11. The control device 80 may set a threshold (VTH) for the output of the sensor 14 and set the position of the holding unit 11 when the output of the sensor 14 is at the threshold (VTH) to the detection position 32.

By using the difference between the outputs of the first sensor 141 and the second sensor 142 as the output of the sensor 14, the effects of the temperature characteristics of the sensor 14 can be canceled out. The orientation of the magnet 15 intersects the movement direction of the holding unit 11, and this may reduce the effect of the length of the magnet 15.

When the sensor 14 is configured as a resolver, the sensor 14 includes an excitation coil and a detection coil. The magnet 15 is replaced by a non-excitation coil. In this case, the material of the core of the non-excitation coil disposed in place of the magnet 15 can be adjusted so that the waveform of the voltage detected by the detection coil has a desired waveform. The material of the core of the non-excitation coil disposed in place of the magnet 15 may be adjusted so that the voltage detected by the detection coil varies linearly. Cores of different materials may be disposed depending on the position in the non-excitation coil.

The control device 80 may perform an initial operation to acquire the first absolute displacement at every prescribed timing, not limited to the time when the robot hand 10 is activated. The frequency at which the control device 80 acquires the first absolute displacement may be less than the frequency at which the control device 80 acquires the second absolute displacement.

Although embodiments of the present disclosure have been described based on the drawings and examples, please note that one skilled in the art can make various variations or changes based on the present disclosure. Please note that, therefore, these variations or changes are included within the scope of the present disclosure. For example, the functions and so on included in each constituent part can be rearranged in a logically consistent manner, and multiple constituent parts and so on can be combined into one part or divided into multiple parts.

All the constituent features described in the present disclosure can be combined in any combination, except for combinations in which the features thereof are mutually exclusive. Each of the features described in the present disclosure may be replaced by alternative features that serve the same, equivalent, or similar purposes, unless explicitly stated otherwise. Therefore, unless explicitly stated otherwise, each of the disclosed features is only one example of a comprehensive set of identical or equivalent features.

Furthermore, the embodiments according to the present disclosure are not limited to any of the specific configurations of the embodiments described above. The embodiments according to the present disclosure can be extended to all new features described in this disclosure, or combinations thereof.

### REFERENCE SIGNS

1 robot hand system (4: information acquiring unit, 5: operation range, 6: work start bench, 7: work destination bench, 8: holding target)
2 robot (2A: arm)
10 robot hand (11: holding unit, 12: driving unit, 13: encoder, 16: gear, 17: rail)
14 sensor (14S: sensor reference position, 14W: sensor output waveform, 14P: detection point)
15 magnet (15N: N pole, 15S: S pole, 15C: magnet reference position)
30 movement limit point
31 initial position
32 detection position
33 target position
80 control device

1. A robot hand system comprising:
a robot hand including at least one holding unit configured to hold a holding target, a driving unit configured to move the holding unit, an encoder configured to detect a movement distance of the holding unit, and a sensor configured to detect a magnet disposed around the holding unit and a positional change with respect to the magnet; and
a control device configured to control the driving unit based on outputs of the sensor and the encoder,
wherein either the magnet or the sensor is disposed to be capable of moving in accordance with movement of the holding unit.

2. The robot hand system according to claim 1,
wherein the driving unit is controlled using a position of the holding unit where output of the sensor is a prescribed value as a sensor reference position.

3. The robot hand system according to claim 2,
wherein the prescribed value is ½ a maximum value of an output of the sensor.

4. The robot hand system according to claim 2,
wherein the prescribed value is a value representing a boundary between an N pole and an S pole of the magnet.

5. The robot hand system according to claim 2,
wherein an output of the sensor varies in a step-like manner before and after the prescribed value.

6. The robot hand system according to claim 1,
wherein an N pole and an S pole of the magnet are arranged side by side in a movement direction of the holding unit.

7. The robot hand system according to claim 2,
wherein the sensor includes a first sensor and a second sensor, and
a difference between an output of the first sensor and an output of the second sensor is an output of the sensor.

8. The robot hand system according to claim 7,
wherein an N pole and an S pole of the magnet are arranged side by side in a direction intersecting a movement direction of the holding unit.

9. The robot hand system according to claim 1,
wherein the control device is configured to acquire a first absolute displacement representing a displacement of the holding unit from a hand reference position to a sensor reference position, the hand reference position being a movement limit point of the holding unit, and
control the driving unit based on the first absolute displacement.

10. The robot hand system according to claim 9,
wherein the control device is configured to acquire a first relative displacement representing a displacement from a position of the holding unit at a time of power on to the sensor reference position, and
control the driving unit based on the first absolute displacement and the first relative displacement.

11. The robot hand system according to claim 10,
wherein the control device is configured to acquire a second relative displacement representing a displacement from a position of the holding unit at a time of power on to a target position, a correction displacement representing a difference between the first relative displacement and the second relative displacement, a second absolute displacement representing a sum of the first absolute displacement and the correction displacement, and a target displacement with respect to the movement limit point before holding of the holding target is performed, and
judge suitability of a position of the holding unit by comparing the second absolute displacement and the target displacement.

12. The robot hand system according to claim 10,
wherein the control device moves the holding unit from one end of a movable range to another end of the movable range after calculating the first relative displacement, and outputs an error if movement of the holding unit is not completed within a prescribed time.

13. The robot hand system according to claim 9, further comprising:
a recording unit configured to record various data needed for control of a robot hand,
wherein the recording unit includes a non-volatile memory, and
the first absolute displacement is recorded in the non-volatile memory.

14. The robot hand system according to claim 9,
wherein the control device is configured to acquire the first absolute displacement every prescribed timing.

15. The robot hand system according to claim 14,
wherein a frequency at which the first absolute displacement is acquired is lower than a frequency at which a second absolute displacement is acquired, the second absolute displacement representing a sum of the first absolute displacement and a correction displacement, the correction displacement representing a difference between a first relative displacement representing displacement from a position of the holding unit at a time of power on to the sensor reference position and a second relative displacement representing a displacement from the position of the holding unit at the time of power on to a target position.

16. The robot hand system according to claim 9,
wherein the at least one holding unit includes multiple holding units and the movement limit point corresponds to a state in which the multiple holding units are positioned closest to each other.

17. A control method comprising:
controlling the robot hand system according to claim 1.

18. A robot hand comprising:
at least one holding unit configured to hold a holding target;
a driving unit configured to move the holding unit;
an encoder configured to detect a movement distance of the holding unit;
a magnet; and
a sensor configured to detect a positional relationship with the magnet,
wherein either the magnet or the sensor is disposed to be capable of moving in accordance with movement of the holding unit.

19. A control device configured to control the robot hand according to claim 18.
